(19) United States
(12) Patent Application Publication
(10) Pub. No.: US 2018/0029425 A1
(43) Pub. Date: Feb. 1, 2018

(54) NOISE-REDUCING DEVICE FOR A VEHICLE

(71) Applicant: Jaguar Land Rover Limited, Coventry, Warwickshire (GB)

(72) Inventors: Delphine NOURZAD, Coventry, Warwickshire (GB); Barry SLATER, Coventry, Warwickshire (GB); Bill PARSONS, Coventry, Warwickshire (GB); Gary CRIPPS, Coventry, Warwickshire (GB); David BEES, Coventry, Warwickshire (GB)

(21) Appl. No.: 15/549,976

(22) PCT Filed: Mar. 3, 2016
(86) PCT No.: PCT/EP2016/054582

§ 371 Date: Aug. 9, 2017

(30) Foreign Application Priority Data
Mar. 5, 2015 (GB) 1503714.6

(51) Int. Cl. B60C 19/00; B60B 21/02

(52) U.S. Cl. CPC B60C 19/002; B60B 21/02

(57) ABSTRACT

A noise-reducing device for a vehicle wheel rim comprises two elements arranged to secure the device around the wheel rim. The elements are arranged to form a closed loop that is a close fit with the wheel rim so that the device is self-retaining on the wheel rim. At least one cavity is formed in one of the elements, the cavity having an opening to provide communication between the cavity and the tyre cavity. The cavity is arranged to define at least in part a chamber that acts as a Helmholtz resonator when the device is installed onto the wheel rim.

### TECHNICAL FIELD

The present disclosure relates to a noise-reducing device for a vehicle. Particularly, but not exclusively, the disclosure relates to a device for reducing tyre cavity noise. Aspects of the invention relate to a device, to a wheel rim and to a vehicle.

### BACKGROUND

An important marketing and design concern for modern vehicles is to reduce the level of noise and vibration that is experienced by the occupants. There are many sources of noise in a vehicle, but as engines become more refined and produce less noise, the contribution of road/tyre interactions becomes more noticeable. In modern vehicles, as the vehicle speed exceeds 40 km/h, these road/tyre interactions become the dominant source of interior noise and vibration.

There are two significant contributors to the interior noise related to road/tyre interactions: external noise generated by vibration of the tyre on the road surface; and tyre cavity noise (TCN). TCN originates from resonance of the air column inside the tyre cavity as the tyre wall vibrates due to contact with the road surface. TCN is tonal in nature; that is to say it has one prominent frequency.

It is known for tyres to contain foam to reduce TCN. However, this is an expensive solution, particularly as the noise-reducing foam must necessarily be replaced when the tyre is changed.

Noise-reducing devices that instead fit into a well portion of the rim of the vehicle wheel are also known. Such devices typically rely on Helmholtz resonators as vibration dampers. It is also known to use Helmholtz resonators to reduce noise in exhaust and air intake systems. In its simplest form, a Helmholtz resonator includes a hollow main body defining an internal chamber, the chamber having a single outlet that is formed in a protruding neck extending from the main body. A well-known example of Helmholtz resonance is the sound generated when air is blown across the top of an empty bottle. A Helmholtz resonator has a natural resonant frequency, known as the Helmholtz frequency, which is dependent on a number of parameters, for example the length of the neck or the volume of the cavity.

Known noise-reducing devices require the shape of the wheel rim to be modified such that it complements the shape of the noise-reducing device, allowing the device to be attached to the wheel. Such modifications are both costly and time-consuming. Furthermore, this arrangement precludes retrofitting of noise-reducing devices to existing wheels, thereby limiting implementation of the devices.

It is against this background that the present invention has been devised.

### SUMMARY OF THE INVENTION

Aspects and embodiments of the invention provide a noise-reducing device, a wheel rim and a vehicle as claimed in the appended claims.

According to an aspect of the invention, there is provided a noise-reducing device for a vehicle wheel rim. The device may comprise at least two elements arranged to be coupled to secure the device around a region of the wheel rim that is configured to form part of a tyre cavity. The device may further comprise at least one cavity formed in one of the elements, the or each cavity having an opening providing communication between the or each cavity and the tyre cavity. The elements may be arranged to form a closed loop when coupled that is a close fit with the wheel rim, so that the device is self-retaining on the wheel rim. The or each cavity may be arranged to define at least in part a chamber that acts as a Helmholtz resonator when the device is installed onto the wheel rim.

This aspect of the invention provides the advantage that, by virtue of the coupling of the elements around the wheel rim and the close fit of the resulting closed loop with the wheel rim, the device is self-retaining on the wheel rim. The wheel rim therefore does not need to be modified to accommodate the noise-reducing device, for example to provide features on the wheel rim to retain the device. Therefore, devices in accordance with this aspect of the invention can be retro-fitted to substantially any wheel rim.

The or each cavity may be defined by a concavity in one of the elements, in which case a perimeter of the or each concavity is arranged to seal against a surface of the wheel rim when the device is fitted to the wheel rim so that the surface of the wheel rim and the or each concavity together define the or each chamber. In this open-backed arrangement, the cavities of the device cooperate with the wheel rim to create the required chambers for noise-reducing Helmholtz resonance. The fact that the cavities are open-backed means that the elements can be more lightweight, and also easier to manufacture. In this embodiment, the device may comprise a channel around the perimeter of the or each concavity, the channel being arranged to receive a sealing member.

Alternatively, the or each cavity may be closed-backed to define a self-contained chamber. This provides a more robust device that is easier and quicker to install onto the wheel rim compared with the open-backed embodiment, since there is no need to provide a seal around each cavity.

The or each opening may be formed on a respective protrusion that extends into the or each cavity, in which case the or each protrusion is provided with a passage which communicates with the respective opening.

In an embodiment, the or each opening breaks out flush with an outer surface of the device. This provides a degree of protection from ingress of fluids such as puncture sealant or water, which could otherwise alter the sonic characteristics of the resonator.

Each element may comprise at least one cavity. This improves the effectiveness of the device at reducing tyre cavity noise. The cavities can be tuned to the same frequency to maximise the effectiveness of the noise-reducing device at that frequency. Advantageously, this frequency can be the same as the tonal frequency of the tyre cavity noise. In other embodiments, the resonators may be tuned to different frequencies, allowing the device to reduce noise across a range of frequencies in order to handle variations in the tyre cavity noise frequency caused by changes in temperature, for example.

Each element may comprise the same number of cavities. In such embodiments, each element may be substantially identical. This means that the two elements can be manufactured less expensively.

The device may comprise a fastening member arranged to encircle the elements and to apply inward radial force to press the elements onto the wheel rim, in use. In this case, the elements may comprise a circumferential groove arranged to receive the fastening member. This ensures that the device is tightly retained against the wheel rim.

Each element may comprise an axially extending flange arranged to abut a lip of the wheel rim so as to ensure correct positioning of the device on the wheel rim, to ease installation of the device.

In some embodiments, at least one of the elements includes a recess that is arranged to accommodate a tyre pressure monitoring system and the recess may be defined by a taper at an end of the element. This aids fitment of the device to wheel rims that include a tyre pressure monitoring system.

In another aspect of the invention, there is provided a wheel having a wheel rim comprising a noise-reducing device. The device may comprise at least two elements that are coupled to secure the device around a region of the wheel rim that is configured to form part of a tyre cavity. The device may further comprise at least one cavity formed in one of the elements, the or each cavity having an opening providing communication between the or each cavity and the tyre cavity. The coupled elements may form a closed loop that is a close fit with the wheel rim, so that the device is self-retaining on the wheel rim. The or each cavity may define at least in part a chamber that acts as a Helmholtz resonator.

The wheel rim may comprise a damping layer and/or an adhesive layer between the device and the wheel rim. This ensures that the device is decoupled from vibrations of the wheel.

According to another aspect of the invention, there is provided a vehicle comprising a noise-reducing device according to the above described aspect, or a wheel rim comprising such a noise-reducing device. The wheel rim may further comprise a damping layer and/or an adhesive layer between the device and the wheel rim to prevent movement of the device on the wheel rim.

According to a further aspect of the invention, there is provided a method of reducing tyre cavity noise. The method may comprise coupling at least two elements around a region of a wheel rim that is configured to form part of a tyre cavity such that the elements form a closed loop that is a close fit with and self-retaining on the wheel rim, and using at least one of the elements to define at least in part a chamber that acts as a Helmholtz resonator when the elements are attached to the wheel rim.

The method may comprise sealing a perimeter of a cavity formed in one of the elements against a surface of the wheel rim to define the chamber.

The method may comprise attaching a fastening member arranged to encircle the elements and to apply inward radial force to press the elements onto the wheel rim.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a perspective view of a noise-reducing device in accordance with an embodiment of the present invention;

FIG. 2 is a perspective view of the noise-reducing device of FIG. 1 installed on a wheel rim of a vehicle;

FIG. 3 is a perspective view of a portion of the noise-reducing device of FIG. 1;

FIG. 4 is a cross-section view of the noise-reducing device of FIG. 1;

FIG. 5 corresponds to FIG. 2 but shows the noise-reducing device and the wheel rim in axial cross-section;

FIG. 6 is a perspective view of the noise-reducing device of FIG. 1, showing an opening to the neck shown in FIG. 3;

FIG. 7 is another perspective view, from a different angle, of the noise-reducing device of FIG. 1, showing another opening to the neck shown in FIG. 3;

FIG. 8 is a perspective view of the noise-reducing device of FIG. 1, showing an attachment mechanism; and

FIG. 9 is a perspective view of a vehicle incorporating the noise-reducing device of FIG. 1.

### DETAILED DESCRIPTION

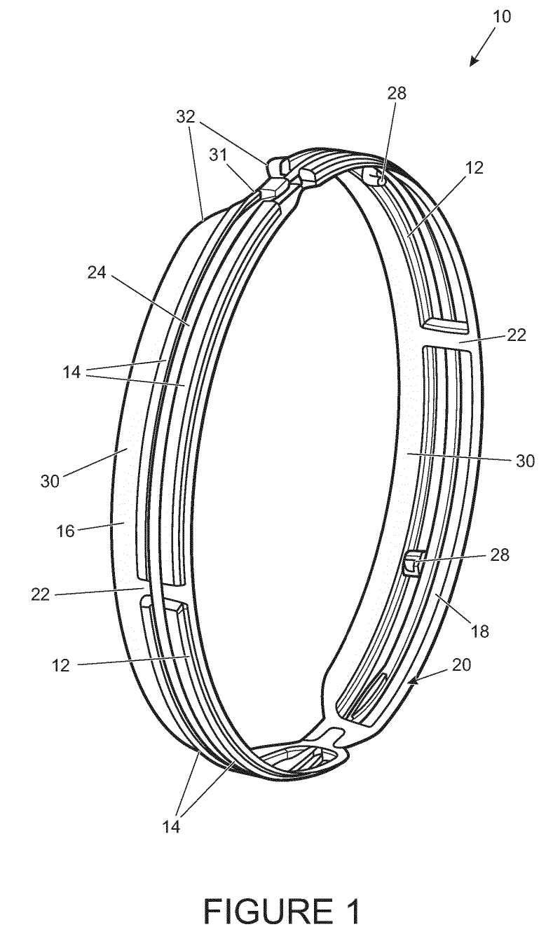

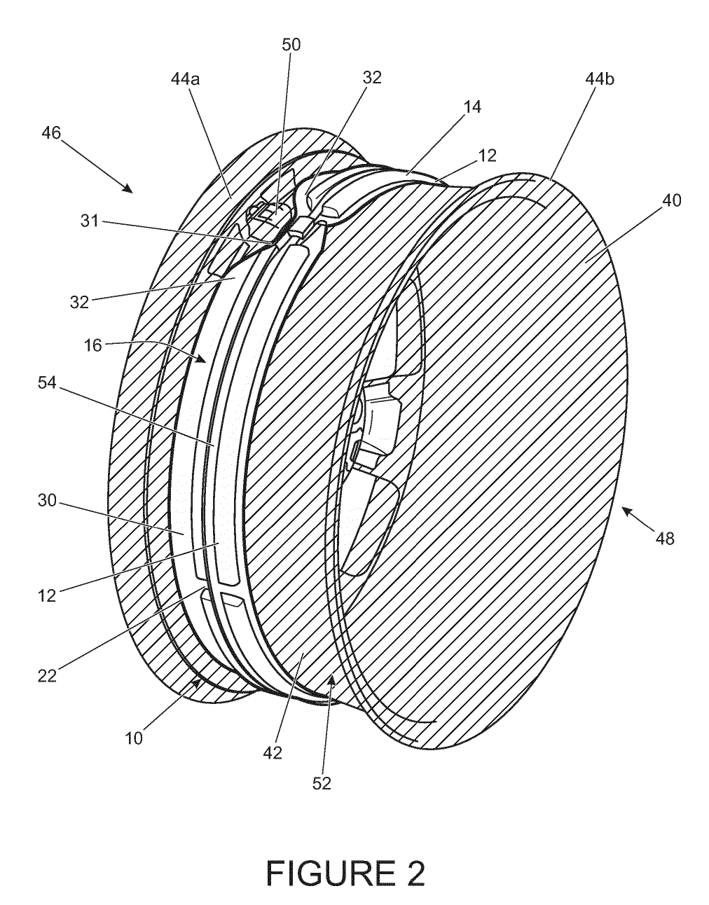

Referring to FIG. 1, a noise-reducing device 10 in accordance with an embodiment of the present invention is shown. The noise-reducing device 10 is generally annular in form and attaches around a vehicle wheel and specifically a wheel rim (shown in FIG. 2). The noise-reducing device 10 is open-backed and cooperates with the wheel rim to create chambers that act as Helmholtz resonators to damp vibration of an air column defined within a tyre cavity, the tyre cavity being defined as the volume enclosed by the surface of the wheel rim and the interior surface of a fitted tyre.

In this embodiment, the noise-reducing device 10 is formed from two elements or halves 12 that connect at diametrically opposed points on the device 10. It will be appreciated that although the elements of the device are referred to as “halves” of the device, the two parts need not be identical nor form exact halves in shape, size nor mass of the whole device.

As will be explained later, the connection between the two sections may be realised in many different ways. Each half 12 is a band of plastics material formed as a half-ring, such that the two halves 12 together create a continuous ring. The width of the device 10 is relatively small compared with its radius, and is less than the width of the wheel rim.

Protrusions 14 extend radially from an outer surface 16 of the noise-reducing device 10, the protrusions 14 being hollow to define concavities 18 on an inner surface 20 of the device 10.

In this embodiment, each half 12 of the device 10 includes two protrusions 14 separated by a gap 22, such that there are two concavities 18, each of which occupies almost a quarter of the overall circumference of the device 10. An upper surface of each protrusion 14 includes a central circumferential groove 24 along its entire length.

In this embodiment, the cross-section of each protrusion 14 is uniform circumferentially. However, in alternative embodiments, the protrusions 14 may take many different shapes and their cross-sections may vary around the circumference of the device 10 so as to tailor the vibration damping response of the device 10 as required.

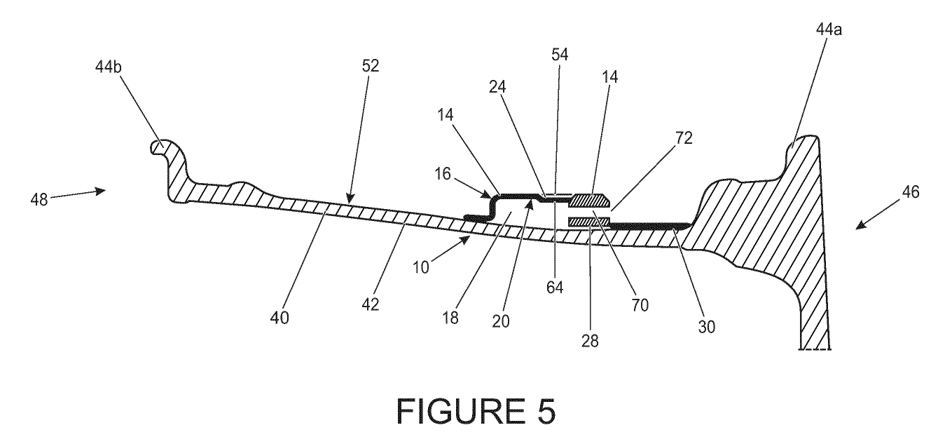

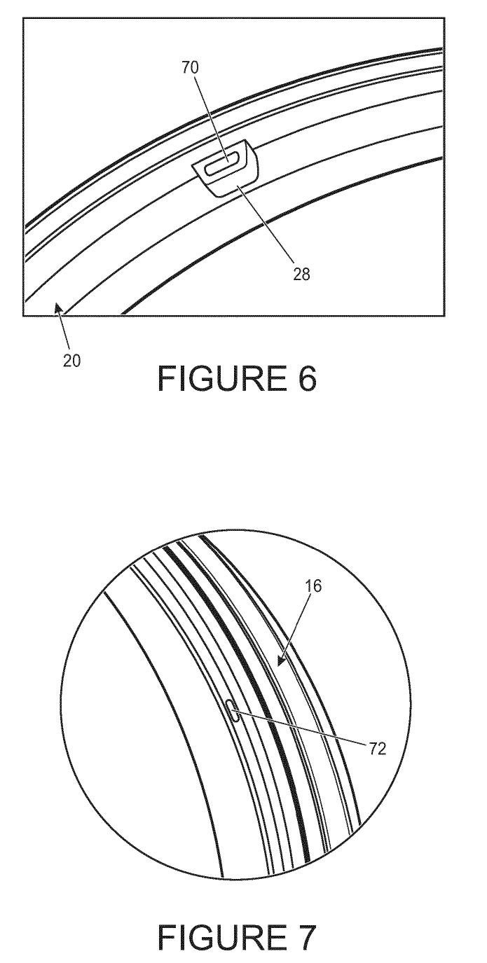

Each concavity 18 includes a single opening (shown in FIGS. 5 to 7) that provides communication between the concavity 18 and the outer surface 16 of the device 10. As is explained in more detail below with reference to FIGS. 6 and 7, the opening breaks out onto the outer surface 16 of the device 10 flush with that surface 16, while on the inner surface 20 a protrusion into the concavity 18 defines a neck 28 on which the opening is located.

Each half 12 of the noise-reducing device 10 also includes a flange 30 that projects axially away from the protrusions 14. The flanges 30 have tapered end portions 32 such that a v-shaped gap 31 is defined between neighbouring flanges 30 when the two halves 12 of the device 10 are coupled together.

Referring to FIG. 2, the device 10 of FIG. 1 is shown attached to and encircling a wheel rim 40 of a vehicle wheel. As will be familiar to the skilled reader, the wheel rim 40 includes a roughly cylindrical central portion 42 with radially enlarged lips 44a, 44b at either side, those lips 44a, 44b being arranged to engage in use a bead of a tyre (not shown). The profile of the central portion 42 of the wheel rim 40 is slightly tapered and as such, the circumference of the wheel rim 40 on the outboard side 46 is smaller than the circumference on the inboard side 48. The wheel rim 40 also includes a tyre pressure monitoring system (TPMS) 50, which protrudes from the curved surface 52 of the wheel rim 40 at a point close to the outboard lip 44a.

The interior circumference and profile of the noise-reducing device 10 are arranged to correspond to the circumference and taper of the central portion 42 of the wheel rim 40. Therefore, when the device 10 is installed around the wheel rim 40, the inner surface 20 of the device 10 seals against the surface 52 of the central portion 42 of the wheel rim 40, enclosing a volume of air within each concavity 18. This creates four separate resonance chambers when the device 10 is retained against the wheel rim 40.

As the device 10 forms a continuous ring, it cannot fall off the wheel rim 40 once assembled. Moreover, as the device 10 is sized for a close fit with the wheel rim 40, it will generally maintain its position on the wheel rim 40 once installed. In this way, the device 10 is self-retaining on the wheel rim 40. This sits in contrast with known noise-reducing devices, for which bespoke modifications must be made to each wheel rim to enable installation of the device.

It is noted that, as the noise-reducing device 10 is open-backed, the concavities 18 are not closed to form resonance chambers until the device is attached to the wheel rim 40. The noise-reducing device 10 therefore cooperates with the wheel rim 40 to create the partially closed volumes that are required for Helmholtz resonance. In this way, the noise-reducing device 10 of this embodiment of the invention can be more lightweight and less costly to manufacture than the closed cell resonator arrangements known from the prior art.

In alternative embodiments the device may be closed-backed, in which case the resonance chambers are formed integrally as part of the device rather than in conjunction with the wheel rim 40. In comparison with the open-backed arrangement described above, a closed-backed arrangement provides benefits such as increased strength and robustness, along with easier installation by virtue of the fact that there is no need to ensure a seal around the concavities as with the open-backed design. Furthermore, as with the open-backed arrangements, a closed-back embodiment also has the advantage that the noise-reducing device 10 is self-retaining on the wheel rim 40, in that the wheel rim 40 does not require modification in order to support the device.

Open-backed arrangements can be manufactured using injection moulding or extrusion moulding, for example, whereas blow moulding may be required for a closed-backed arrangement.

A fastening member in the form of a retaining band 54 fits into the groove 24 on the exterior surface 16 of the device 10 to ensure that the device 10 is held firmly against the surface 52 of the wheel rim 40. The retaining band 54 is arranged to encircle the device 10 and to apply inward radial force to press the two halves 12 of the device 10 onto the wheel rim 40. The ends of the retaining band 54 may have a buckle or cable tie strap mechanism, or they may be fused or bonded together.

The interior surfaces of the flanges 30 of the noise-reducing device 10 are also arranged to correspond to the circumference and taper of the central portion 42 of the wheel rim 40. Therefore, when the device 10 is installed around the wheel rim 40, the inner surface of the flange is in close contact with the surface 52 of the central portion 42 of the wheel rim 40. The edge of the flange 30 abuts the wheel lip 44a so that the device 10 is installed and maintained such that the concavities 18 are correctly distanced from the wheel lip 44a. One of the v-shaped gaps 31 between neighbouring flanges 30 accommodates the TPMS protrusion 50, allowing the flange 30 to fit around the TPMS 50. In alternative embodiments, a gap or cut-out portion may be defined at another point on the device 10 in order to accommodate the TPMS protrusion 50.

The openings into each concavity 18 connect the chambers to the tyre cavity (when a tyre is installed), and the necks 28 defined by the box-like protrusions allow the resonance chambers to act as Helmholtz resonators. The vibration of the air column inside the tyre cavity is damped by the Helmholtz resonance in the chambers, reducing the TCN close to its source. As noted above, the TCN is tonal, and so, elegantly, the resonators are identical and tuned to the frequency of the TCN by appropriate configuration of the concavities 18. For example, the resonator can be tuned to a desired frequency by altering the volume of air contained in the resonance chambers. The volume of air in the chambers affects the Helmholtz frequency of the resonator: the greater the volume, the lower the Helmholtz frequency.

In the following description, reference will be made to a single resonator; it should, however, be appreciated that this description equally applies to any other resonator of the noise-reducing device 10.

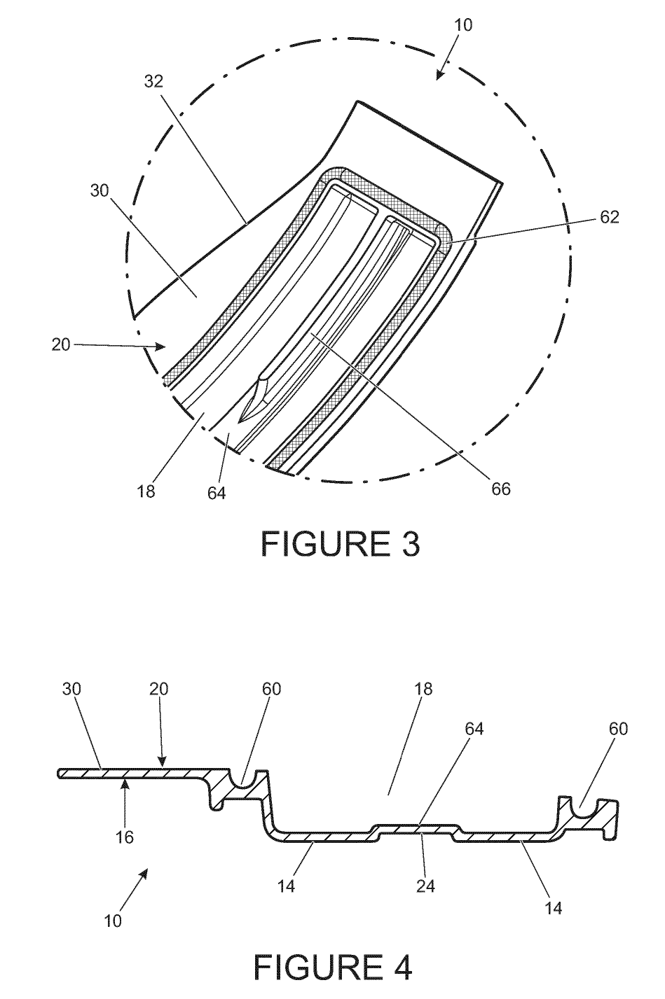

FIG. 3 shows the inner surface 20 of the noise-reducing device 10 in more detail, and a part of a concavity 18 can be seen; FIG. 4 shows a corresponding portion of the noise-reducing device 10 in cross-section. As can be seen most clearly in FIG. 4, around the edge of the concavity 18 a channel 60 is formed on the inner surface 20 of the noise-reducing device 10. Referring to FIG. 3, a rubber O-ring 62 (not shown) is received in the channel 60 and is used to ensure an airtight seal between the noise-reducing device 10 and the wheel rim 40. This seal maintains the resonance characteristics of each of the chambers so that each Helmholtz resonator remains tuned to the TCN frequency. Ensuring firm contact between the noise-reducing device 10 and the wheel rim 40 also prevents rattle and resists rotation of the device 10 relative to the wheel in use. In other embodiments, alternative sealing material may be provided, for example in the form of a layer of foam or adhesive covering the surface area in contact with the wheel rim 40. In closed-backed embodiments, no seal is required as the chambers are self-contained. However, foam or adhesive material may still be used between the device 10 and the wheel rim 40 to minimise transmission of vibration.

It can also be observed from FIG. 3 that a central protrusion 64 is present in the concavity 18, the central protrusion 64 corresponding to the central groove 24 formed on the outer surface 16 of the noise-reducing device 10. A secondary protrusion 66 extends radially from the central protrusion 64 around part of its circumference. The secondary protrusion 66 reinforces the structure of the concavity 18, making it stiffer and preventing the concavity 18 from deforming, for example due to air vibration. This ensures that the volume of the chamber does not vary significantly during use. Additionally, reinforcement of the concavity 18 protects the device 10 from damage if the central retaining band 54 is over-tightened.

Features of the neck 28 of the resonator will now be described with reference to FIGS. 5 to 7. FIG. 5 shows the assembly of FIG. 2, namely the noise-reducing device 10 installed on the wheel rim 40, in axial cross-section. As can be seen, the device 10 is held against the central portion 42 of the wheel rim 40, with the edge of the flange 30 abutting the outboard lip 44a. The cross-section is taken through the portion of the device 10 that includes the neck 28. FIGS. 6 and 7 are perspective views of the noise-reducing device 10, FIG. 6 showing a portion of the inner surface 20 including the neck 28, and FIG. 7 showing a corresponding portion of the outer surface 16 including the opening 72.

As noted above, the wall of the noise-reducing device 10 has an opening 72 to allow air to pass between the tyre cavity and the chamber via the neck 28. As best seen in FIG. 6, the neck 28 is defined by a box-like protrusion that extends axially into the chamber along the inner surface 20 of the noise-reducing device 10. The edges of the protrusion are rounded for ease of manufacturing. FIG. 5 shows that a central bore 70 formed in the neck 28 provides communication between the chamber and the tyre cavity.

As can be seen in FIG. 7, and as noted previously, the opening 72 to the neck 28 on the outer surface 16 is flush with that surface 16. This provides a degree of protection from ingress of fluids such as puncture sealant or water, which could otherwise alter the sonic characteristics of the resonator.

The length and cross-sectional area of the bore 70 of the neck 28 are both relevant parameters for determining the Helmholtz frequency. Therefore, the resonator can be tuned to a desired frequency, typically the TCN frequency, by varying the length or cross-sectional area of the bore 70. In other embodiments, the form of the neck 28 may be adapted to improve the sound absorption capacity of the resonator. For example, in this embodiment opposing walls of the bore 70 are parallel, but in other embodiments the walls may be angled to form a tapered neck.

Noise-reducing devices 10 in accordance with embodiments of the present invention allow reduction of the TCN close to its source, preventing transfer of noise to the vehicle cabin (not shown). As noted above, the air column inside the tyre cavity vibrates due to the vibration of the tyre wall caused by contact with the road surface. This establishes a standing wave inside the tyre cavity with the characteristic frequency of the TCN. Since the Helmholtz resonators of the noise-reducing device 10 are tuned to the same frequency as the TCN, they exhibit Helmholtz resonance in response to this excitation. Each Helmholtz resonator acts to damp the vibration of the air column by acting as a simple harmonic oscillator. By analogy with a mass on a spring, the air within the chamber behaves like the spring and the air within the neck 28 behaves like the mass. The oscillations of the air column are therefore damped and the TCN is reduced.

To maximise the effectiveness of the noise-reducing device 10 at a particular frequency, in this embodiment all of the resonators are identical. Alternatively, dissimilar resonators may be tuned to the same frequency if desired through control of the relevant parameters. In other embodiments, the resonators may be tuned to different frequencies, allowing the device to reduce noise across a range of frequencies in order to handle variations in the TCN frequency caused by changes in temperature, for example. This may be achieved by varying any one or more of the relevant parameters of the resonators; such as the resonator chamber volume or resonator neck 28 length.

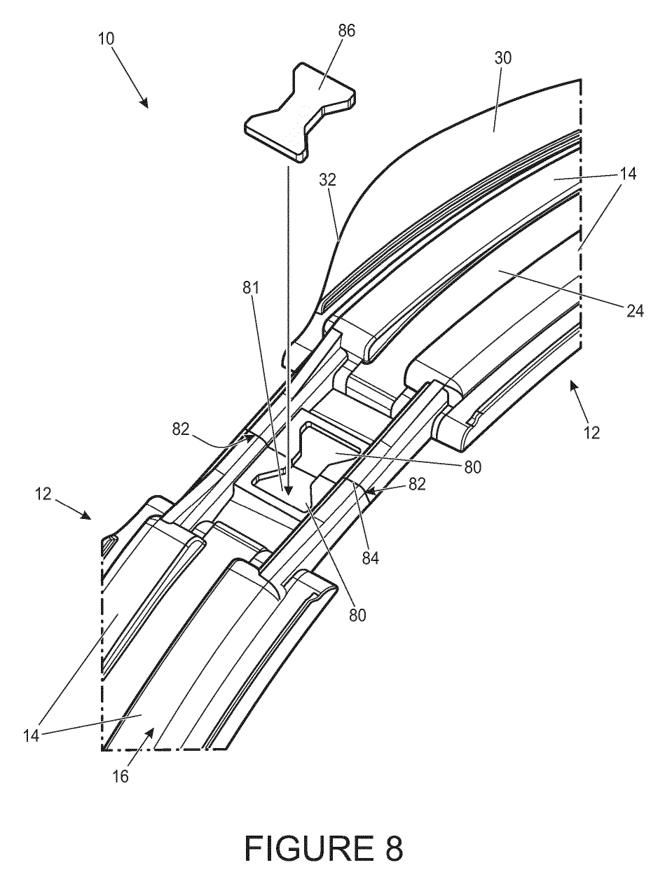

It will be appreciated by a person skilled in the art that connection of the two halves 12 of the device 10 could be realised in many different ways. One example is described below, with reference to FIG. 8, which shows the two halves 12 of the noise-reducing device 10 being attached together, in an arrangement not unlike a jigsaw. In the following description one of the connections will be described; it should, however, be noted that the diametrically opposed connection point on the noise-reducing device 10 will typically connect in the same manner. Alternatively, one of the connections may be semi-permanent, for example a hinged connection, to simplify assembly.

The outer surface 16 of each half 12 of the noise-reducing device 10 includes a depression 80 extending from its connecting edge 82. When the connecting edges 82 of the two halves 12 of the device 10 are abutted against one another the depressions 80 align, forming a single continuous recess 81 spanning the joint 84 on the outer surface 16 of the device 10.

This recess 81 has a generally hourglass shape and an attachment piece or clip 86 of complementary shape is provided to fit inside the recess 81. By virtue of the interlocking engagement between the recess 81 and the hourglass shape of the clip 86, the two halves 12 of the device 10 cannot be pulled apart when the clip 86 is inserted. The retaining band 54 fits over the clip 86 to hold it in place in the recess 81. Additionally or alternatively, one half 12 of the device 10 may be provided with pins (not shown) extending from the connecting edge 82 and the other half 12 with holes (not shown) to receive said pins, to enhance the integrity of the joint 84.

Providing the noise-reducing device 10 in two halves 12 allows easy installation to a wheel rim 40, with the flange 30 and v-shaped gap 31 for the TPMS 50 together facilitating reliable locating of the device 10 on the wheel rim 40. Additionally, since the noise-reducing device 10 is self-retaining and open-backed, the wheel rim 40 need not be modified to complement the form of the noise-reducing device 10, as is necessary with prior art arrangements. Therefore, with appropriate sizing the noise-reducing device 10 can be retrofitted to most existing wheel rims 40, provided the interior circumference and profile of the noise-reducing device 10 are tailored to match the dimensions of the wheel rim 40.

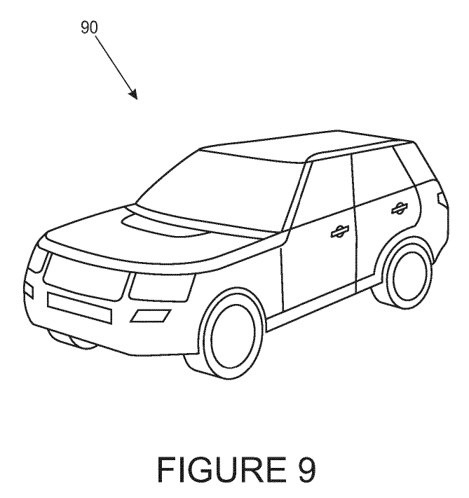

As can be seen from FIG. 9, the invention also extends to a vehicle 90 incorporating a noise-reducing device 10 as described above.

It will be appreciated by a person skilled in the art that the embodiments of the present invention described above could be modified to take many other alternative forms without departing from the inventive concept defined by the claims. For example, an adhesive band or foam could be provided underneath the device to decouple it from the wheel vibrations.

1. A noise-reducing device for a vehicle wheel rim, the device comprising:
at least two elements arranged to be coupled to secure the device around a region of the wheel rim that is configured to form part of a tire cavity; and
at least one cavity formed in one of the at least two elements, the at least one cavity having an opening to provide communication between the at least one cavity and the tire cavity;
wherein the at least two elements are arranged to form a closed loop when coupled that is a close fit with the wheel rim so that the device is self-retaining on the wheel rim; and
wherein the at least one cavity is arranged to define at least in part a chamber that acts as a Helmholtz resonator when the device is installed onto the wheel rim.

2. The device of claim 1, comprising a fastening member arranged to encircle the at least two elements and to apply inward radial force to press the at least two elements onto the wheel rim, in use.

3. The device of claim 2, wherein the at least two elements comprise a circumferential groove arranged to receive the fastening member.

4. The device of claim 1, wherein the at least one cavity is defined by a concavity in one of the at least two elements, and wherein a perimeter of the concavity is arranged to seal against a surface of the wheel rim when the device is fitted to the wheel rim so that the surface of the wheel rim and the concavity together define the or each chamber, in use.

5. The device of claim 4, comprising a channel around the perimeter of the concavity, the channel being arranged to receive a sealing member.

6. The device of claim 1, wherein the at least one cavity is closed-backed to define a self-contained chamber.

7. The device of claim 1, wherein the opening is formed on a respective protrusion that extends into the at least one cavity, and wherein the protrusion is provided with a passage which communicates with the opening.

8. The device of claim 1, wherein the opening breaks out flush with an outer surface of the device.

9. The device of claim 1, wherein each of the at least two elements comprises at least one cavity.

10. The device of claim 9, wherein each of the at least two elements comprises the same number of cavities.

11. The device of claim 10, wherein each of the at least two elements is substantially identical.

12. The device of claim 1, wherein each of the at least two elements comprises an axially extending flange arranged to abut a lip of the wheel rim so as to ensure correct positioning of the device on the wheel rim.

13. The device of claim 1, wherein at least one of the at least two elements includes a recess that is arranged to accommodate a tire pressure monitoring system.

14. The device of claim 13, wherein the recess is defined by a taper at an end of at least one of the at least two elements.

15. A wheel having a wheel rim comprising a noise-reducing device according to claim 1.

16. The wheel rim of claim 15, further comprising a damping layer and/or an adhesive layer between the device and the wheel rim.

17. A vehicle comprising the noise-reducing device of claim 1.

18. (canceled)

19. A method of reducing tire cavity noise, the method comprising:
coupling at least two elements around a region of a wheel rim that is configured to form part of a tire cavity such that the at least two elements form a closed loop that is a close fit with and self-retaining on the wheel rim; and
using at least one of the at least two elements to define at least in part a chamber that acts as a Helmholtz resonator when the at least two elements are attached to the wheel rim.

20. The method of claim 19, comprising sealing a perimeter of a cavity formed in one of the at least two elements against a surface of the wheel rim to define the chamber.

21. (canceled)
